(19) United States
(12) Patent Application Publication
(10) Pub. No.: US 2021/0394060 A1
(43) Pub. Date: Dec. 23, 2021

(54) METHOD AND SYSTEM FOR AUTOMATICALLY GENERATING VIDEO HIGHLIGHTS FOR A VIDEO GAME PLAYER USING ARTIFICIAL INTELLIGENCE (AI)

(71) Applicant: FalconAI Technologies, Inc., Cambridge, MA (US)

(72) Inventors: Olcay Yilmazcoban, Istanbul (TR); Berk Ozer, Istanbul (TR)

(21) Appl. No.: 16/909,031

(22) Filed: Jun. 23, 2020

(51) Int. Cl. A63F 13/497; A63F 13/798; A63F 13/86; G06K 9/00; G06K 9/62

(52) U.S. Cl. CPC A63F 13/497; A63F 13/798; A63F 13/86; A63F 2300/577; G06K 9/6256; A63F 2300/634; G06K 9/00724

(57) ABSTRACT

The disclosure provides a method and system for automatically generating video highlights for a video game involving one or more players. To start with, the method and system extracts game-related information or statistics from an in-game event stream and from one or more data sources using a plurality of Application Programming Interfaces (APIs) and analyses the in-game event stream using an AI module. In an ensuing step, the method and system predicts a win probability of the game in real-time based on the game-related information and detects if the win probability of the game fluctuates beyond a predefined threshold using the AI module. In response to detecting that the win probability fluctuates beyond a predefined threshold, the method and system correlates one or more significant in-game events with the win probability fluctuations. Thereafter, video highlights of the game are generated based on the one or more significant in-game events.

### FIELD

The disclosure generally relates to automatically generating video highlights for a video game player using Artificial Intelligence (AI) techniques. Specifically, the disclosure relates to a method and system for automatically generating video highlights for the video game player by predicting a win probability of the game in real-time using the AI module to provide education, personalized coaching and entertainment for a gaming community.

### BACKGROUND

Playing video games is becoming increasingly complex with advancements in the video gaming technology. Initially, every player involved in a video game is provided with a predefined set of rules such as, but not limited to, the dos and dont's to be considered by the player, wherein the predefined set of rules are provided in detail to the player before the commencement of the game and during game play. To achieve a goal in the game, a linear sequence of events is presented to the player and the player is required to respond with a linear sequence of actions. However, the predefined set of rules and the linear sequence of events restricts the player from moving in different paths to attain the goal.

Conventionally, the predefined set of rules for playing video games are hassle-free and allow video games to be open-ended, where the player freely interacts in any manner, performs any action and progresses differently in the video game. However, the freedom provided to the players with the predefined set of rules confuses new players who are unfamiliar with the video game and challenges a game developer with respect to creating an effective game experience for the new players. Typically, the video game code aids or adapts the video game in accordance with several possible scenarios and the video game code is improved to provide a more adaptive game assistance.

Further, the popularity and complexity of video games has increased over the years, providing two and three dimensional high-definition graphics, complex game play, and challenging puzzles to the players. The trends and innovations created in the field of video games has led to an increase in quality of gaming and enhancement of user experience during game play, at the same time increasing complexities of game play. To overcome these complexities, the player of the game is provided more assistance or help while playing the game. However, the player encounters multiple disruptions in accessing assistance from an internet search while playing the game and this potentially degrades the gaming experience for the player.

Moreover, many conventional video game systems utilize complex branching programs that dictate conduct of characters in the game and provide outcome of game situations in response to status of specific operating parameters. Traditional role-playing games allow the player to control the development of character in the game based on response received for specific queries, options, decisions, and interactions from other characters. However, the video game systems are deficient, because the video game systems do not feature game characters that evolve or learn from experience, age, and/or function in accordance with many different traits. In addition, most of the video gaming systems do not allow end users to breed, develop, train, and compete with the game characters over time.

Also, a new market in the video gaming industry is Esports (electronic sports), or competitive gaming, that is currently exploding across the globe. Esports relates to a form of competition that is facilitated by electronic systems, particularly video games. With Esports, the input of players and teams as well as the output of the Esports system are mediated by human-computer interfaces. Most commonly, Esports takes the form of organized, multiplayer video game competitions, particularly between professional players. Existing coaching or training techniques in Esports involve human coaches who are both expensive and time consuming, and computer systems used for such training purposes do not provide action plans to the user. Further, it is widely known in Esports that getting into slumps and losing matches in a streak happens to players from time to time. To address this, existing coaching techniques employ only human coaches to provide indication to players of the need to take a small break and to advance stronger, and therefore lack automation.

In addition, existing methods are able to train a video game player by generating highlights of video content with human editors/coaches after a video has ended (for instance, after the video stream has concluded), which can consume more time for editing or modifying the video content based on the performance of the players. Therefore, the conventional systems, services, players and platforms are unable to identify and compile (or even extract) highlights from live-streaming media because it is difficult to perform the necessary computational steps in real-time (e.g., without user input) while the video is being broadcast.

Therefore, in light of the above, there is a need for a method and system for providing an improved mechanism of generating video highlights for a video game player in real-time to efficiently provide personalized coaching or training to players in the competitive online gaming environment, especially Esports.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the disclosure.

FIG. 1 illustrates a system for automatically generating video highlights for a video game involving one or more players in accordance with an embodiment of the disclosure.

FIG. 2 illustrates an AI module for learning a player's gaming behavior in accordance with an embodiment of the disclosure.

FIG. 3 illustrates a video highlights generator for automatically generating video highlights of the game in accordance with an embodiment of the disclosure.

FIG. 4 illustrates a flowchart of a method for automatically generating video highlights for a video game involving one or more players in accordance with an embodiment of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the disclosure.

### DETAILED DESCRIPTION

Before describing in detail embodiments that are in accordance with the disclosure, it should be observed that the embodiments reside primarily in combinations of method steps and system components related to automatically generating video highlights for a video game involving one or more players by analyzing an in-game event stream of a player and predicting a win probability of the game in real-time using an Artificial Intelligence (AI) module.

Accordingly, the system components and method steps have been represented where appropriate by conventional symbols in the drawings, showing only those specific details that are pertinent to understanding the embodiments of the disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the disclosure provide a method and system for automatically generating video highlights for a video game involving one or more players. To start with, the method and system extracts game-related information or statistics from an in-game event stream and from one or more data sources using a plurality of Application Programming Interfaces (APIs) and analyses the in-game event stream using an AI module. The game-related information includes one or more of in-game behavior of players and skill usages of players. In an ensuing step, to the method and system predicts a win probability of the game in real-time based on the game-related information and detects if the win probability of the game fluctuates beyond a predefined threshold using the AI module. In response to detecting that the win probability fluctuates beyond a predefined threshold, the method and system correlates one or more significant in-game events from the in-game event stream with the win probability fluctuations. Thereafter, video highlights of the game are generated based on the one or more significant in-game events.

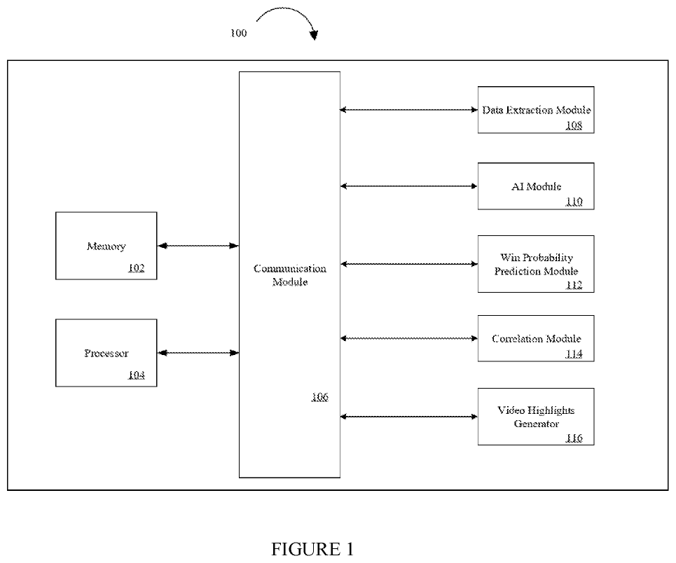

FIG. 1 illustrates a system 100 for automatically generating video highlights for a video game involving one or more players, in accordance with an embodiment of the disclosure.

The video game can be, but need not be limited to, an online video game which can include, but is not limited to, an athletic competition, a match, and a tournament.

As illustrated in FIG. 1, system 100 includes a memory 102 and a processor 104 communicatively coupled to memory 102. Memory 102 and processor 104 further communicate with various modules via a communication module 106. Communication module 106 may be configured to transmit data between modules, engines, databases, memories, and other components of system 100 for use in performing the functions discussed herein. Communication module 106 may include one or more communication types and utilize various communication methods for communication within system 100.

System 100 includes a data extraction module 108 for extracting game-related information or statistics from an in-game event stream and from one or more data sources using a plurality of Application Programming Interfaces (APIs). The game-related information includes, but is not limited to, in-game behavior of players and skill usages of players.

The plurality of APIs include, but need not be limited to, official APIs and unofficial APIs. The official APIs are provided by game developers such as, but not limited to, Riot Games and Valve and serve the statistics corresponding to a player's performance. Subsequently, the unofficial APIs are third-party APIs which extract information related to the game. The third-party APIs can be, but need not be limited to, OpenDota.

In an embodiment, the one or more data sources used for extracting the game-related information are replay files which store the game-related information as encrypted event streams. Open source projects may be used for parsing these replay files which can be extended and customized to suit a project's needs.

Furthermore, the event streams extracted from the one or more data sources are decrypted, parsed and processed to extract any in-game details of a player for analyzing the in-game behavior of players and skill usages of players using an AI module 110. The skill usages of players are determined using AI module 110 by analyzing the changes in the states of skill icons of players in the game.

AI module 110 also analyses the on-screen information during replay for extracting game-related information. The information includes, but is not limited to, locations of in-game entities, gold, health bars and skill usages from a heads-up display (HUD).

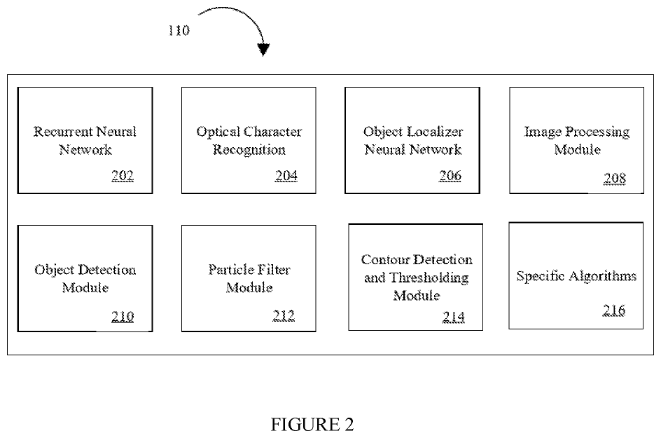

Based on the information extracted from data extraction module 108, AI module 110 learns the in-game behavior of players using various techniques such as, but not limited to, a recurrent neural network, an optical character recognition (OCR), object localizer neural network and specific algorithms. AI module 110 is further described in detail in conjunction with FIG. 2.

System 100 further includes a win probability prediction module 112 which is configured to predict a win probability of the game in real-time based on the game-related information using AI module 110. AI module 110 further detects if the win probability of the game fluctuates beyond a predefined threshold.

In an embodiment, the win probability of the game is predicted using a recurrent neural network in Keras to analyse the gaming behaviour of players. For instance, in League of Legends (LoL), the quantifiable behaviours may include, but need not limited to, an amount of gold, a number of kills and deaths in the game, and the real-time statistics of each team which includes tower states and elite monster kills in the game. The neural network has an input size of 72 (which may be the total number of performance features of 10 players and two teams) and an output size of 1 (the win probability of the first team). The neural network has 1 LSTM hidden layer with 32 units with batch size of 256 for training 10 epochs. The recurrent neural network is then used for predicting the outcome of matches.

In response to detecting that the win probability of the game fluctuates beyond a predefined threshold, a correlation module 114 in system 100 correlates one or more significant in-game events from the in-game event stream with the win probability fluctuations.

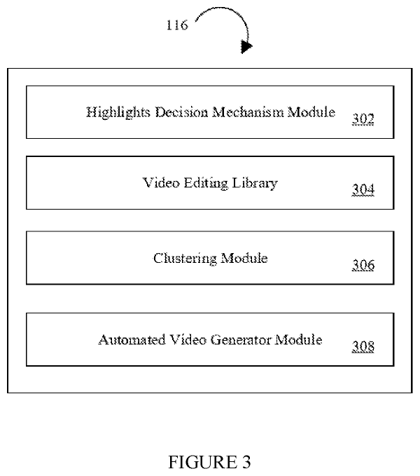

Thereafter, system 100 includes a video highlights generator 116, to automatically generate video highlights based on the one or more significant in-game events. Video highlights generator 116 is further described in detail in conjunction with FIG. 3.

FIG. 2 illustrates AI module 110 for learning a player's gaming behaviour in accordance with an embodiment of the disclosure.

As illustrated in FIG. 2, AI module 110 includes a recurrent neural network 202 with an Adam optimizer and a Binary Crossentropy loss function for predicting the win probability of the game using real-time statistics of players which includes, but is not limited to, an amount of gold, a number of kills and deaths in the game, and the real-time statistics of each team which includes tower states and elite monster kills in the game.

AI module 110 further includes an OCR module 204 in combination with an object localizer neural network 206 for processing extracted text and location of a character/player. OCR module 204 is used for processing text from extracted information and object localizer neural network 206 is used for facilitating character location on a minimap.

OCR module 204 is used for reading textual or numeric information displayed on a game screen. The information of interest is usually static on the screen and their position is known. Each character is detected using a contour detection method in the OpenCV library. The list of all possible characters detected using the contour detection method include: [0, 1, 2, 3, 4, 5, 6, 7, 8, 9, (,), /, −]. Every character detected is compared with each of the ground truth characters using structural similarity index (SSIM) method of Skimage for accepting a best match as the true character.

Object localizer neural network 206 uses an object detection algorithm such as, but not limited to, YOLO. Specifically, tiny YOLO configuration is used with a custom deep architecture and pre-trained weights of darknet with an input size (416, 416, 3). In this case, square minimap images are fed to the input. Output size of object localizer neural network 206 facilitates the number of champions in the game (for instance, 148). For instance, YOLO v3 convolutional neural network is used for detecting LoL champion icons on the minimap. Further, object localizer neural network 206 utilizes a one-hot encoding.

Training is then performed on a synthetic dataset by placing character images on an empty minimap and imitating the minimap display in an actual game. The synthetic dataset is generated by cropping champion images to a square shape and placing 10 of them, for instance, on the minimap in random locations such that 100,000 different minimap images are generated and split into training and validation sets with 90%-10% ratio.

Furthermore, object localizer neural network 206 utilizes a training strategy that trains convolutional part frozen for 20 epochs and then fine tunes the model by training for another 20 epochs with convolutional part unfrozen. In the first stage, Adam optimizer with 1e-3 learning rate is used. In the second stage, the learning rate is decreased to 1 e-4 and “reduce LR on plateau” and “early stopping” strategies are followed.

The processed information from OCR module 204 and object localizer neural network 206 is then passed to an image processing module 208 for detection of events related to a game. Image processing module 208 facilitates straightforward detection of certain events such as, but not limited to, by watching for the greying-out of a relevant button. For instance, a detected event can be based on the skill usage.

Furthermore, AI module 110 includes an object detection module 210 which is trained on dedicated graphics processing units (GPUs) for finetuning the events such as, but not limited to, in-game character locations, detected by image processing module 208.

Thereafter, the output from object detection module 210 is sent to a particle filter module 212 for tracking a detected player/character such as a champion. The detected characters/players are tracked using a particle filter algorithm to provide an estimation of probable occlusions. The tracked data from particle filter module 212 is then passed to a contour detection and thresholding module 214 for providing accurate OCR using techniques such as, but not limited to, SSIM, for achieving 100% accuracy in OCR.

Moving on, AI module 110 utilizes specific algorithms 216 in various tasks such as, but not limited to, role determination/identification, analysing game play features, building suggestions, and ranking distributions. Role identification is performed using a Support Vector Machine (SVM) implemented using sklearn package. The following features of all players in the training dataset are used to train the SVM, and consequently for determining in-game roles of players such as, but not limited to, creep score at 12th minute of the game, the index of starting item among popular starting items, summoner spells chosen before the game, location items such as distances to the top, middle and bottom lanes at each minute until the 12th minute, Experience Points (XP) values at each minute until the 12th minute, and other statistical information. Further, role probabilities of all players (for instance, 5 players) in a team are predicted at the same time and the roles are then assigned using linear sum assignment.

FIG. 3 illustrates video highlights generator 116 for automatically generating video highlights of the game in accordance with an embodiment of the disclosure.

As illustrated in FIG. 3, video highlights generator 116 includes a highlights decision mechanism module 302 for automatically generating video highlights of the game by performing basic processing to determine instances of one or more significant in-game events by looking for abrupt changes in measurable statistics such as, but not limited to, gold, kill, and death ratio. Subsequently, the automatically generated video highlights are edited using a video editing library 304 such as MoviePy. Video editing library 304 edits the video clips by adding transition effects, placing icons, bubbles and texts for annotating and explaining the sequences during the game play, to provide high quality educative video content.

Video highlights generator 116 further includes a clustering module 306 for clustering individual video clips from video editing library 304 for each topic, before being merged into a full video. Clustering is done such that the full videos are created both for professional players and enthusiasts to help educate the gamers and the community at large with best practices such as, by providing directly relevant hints to improve the game play.

Furthermore, video highlights generator 116 includes an automated video generator module 308 for automatically creating videos related to a specific topic. The videos related to a specific topic are created using a predefined set of rules, and these rules are used to obtain videos tailored to specific characteristics. For instance, videos that focus solely on a farming aspect of the game can be created using the predefined set of rules related to farming. The videos are then deployed to educate the players on specific topics when an immediate need for improvement is detected, or for sharing in blogs, or for any other purpose. The videos are also shared for each relevant topic while automatically curating the in-game highlights of professional players. Specifically, a website is created where the in-game highlights of the player are automatically curated and shared for each relevant topic, for providing education, personalized coaching and entertainment for the gaming community.

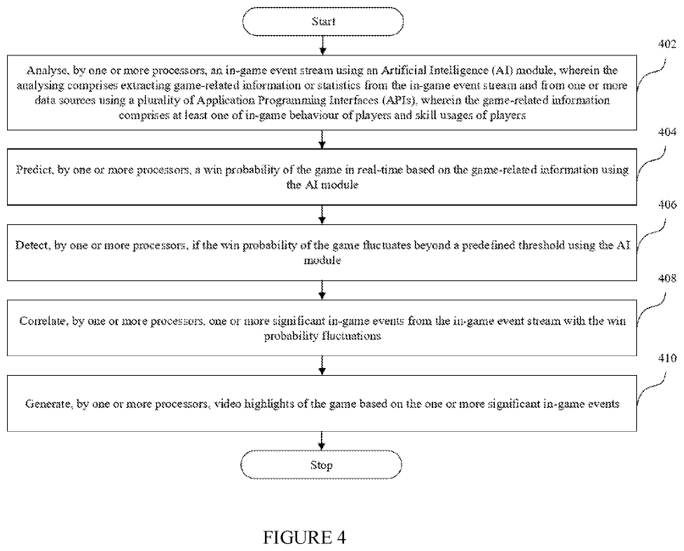

FIG. 4 illustrates a flowchart of a method for automatically generating video highlights for a video game involving one or more players in accordance with an embodiment of the disclosure.

At step 402, AI module 110 analyses an in-game event stream by extracting game-related information or statistics from the in-game event stream and from one or more data sources using a plurality of APIs. The game-related information may include, but need not be limited to, in-game behavior of players and skill usages of players.

The plurality of APIs may include, but need not be limited to, official APIs and unofficial APIs. The official APIs provide statistics corresponding to a player's performance and unofficial APIs are third-party APIs which extract information related to the game. Also, the one or more data sources can be, but need not be limited to, replay files which store the game-related information as encrypted event streams.

Based on the information extracted from data extraction module 108, AI module 110 learns the in-game behavior of players using various techniques including, but is not limited to, recurrent neural network, OCR, object localizer neural network and specific algorithms.

At step 404, win probability prediction module 112 is used to predict the win probability of the game in real-time based on the game-related information using AI module 110. AI module 110 then detects if the win probability of the game fluctuates beyond a predefined threshold using AI module 110 at step 406.

In response to detecting that the win probability of the game fluctuates beyond a predefined threshold, at step 408, correlation module 114 is used to correlate one or more significant in-game events from the in-game event stream with the win probability fluctuations.

Finally, at step 410, video highlights generator 116 generates video highlights of the game based on the one or more significant in-game events using highlights decision mechanism module 302. Further, video highlights generator 116 automatically edits videos for providing explanatory video content and automatically curates the in-game video highlights of professional players for sharing on a website to provide education, personalized coaching, and entertainment for the gaming community.

The present disclosure describes methods for enabling automated video highlights creation using AI techniques, which are cost-effective and less time-consuming. Further, the disclosure supports various Esports genres from Multiplayer Online Battle Arena (MOBA) to Battle Royale including games such LoL, Dota 2 and Fortnite.

The disclosure utilizes automated and scalable AI/computer vision technologies to educate Esports players and enthusiasts to improve their gaming experience by providing descriptive and prescriptive analysis with a personalized roadmap. The disclosure utilizes enhanced processes and techniques for collecting the data related to the user's in-game behavior from different sources, and utilizes various AI methods to learn the user's behavior from the data collected, to perform video highlights creation for Esports players including video gamers and professionals. These video highlights are created considering a player's in-game features. Also, these highlights can be specialized per game which includes team fights and farming. The created video highlights are then uploaded to various video platforms for creating video content. Also, the personalized performance analysis provides a coaching experience to the players based on custom in-game performance metrics.

The disclosure also creates a website containing computer vision driven video highlights of Esports players. Thus, the disclosure provides an automated method to generate customized video highlights and provide personalized performance analysis using automatically generated in-game clips in a time-efficient manner.

Those skilled in the art will realize that the above recognized advantages and other advantages described herein are merely exemplary and are not meant to be a complete rendering of all of the advantages of the various embodiments of the disclosure.

The system, as described in the disclosure or any of its components may be embodied in the form of a computing device. The computing device can be, for example, but not limited to, a general-purpose computer, a programmed microprocessor, a micro-controller, a peripheral integrated circuit element, and other devices or arrangements of devices, which can implement the steps that constitute the method of the disclosure. The computing device includes a processor, a memory, a non-volatile data storage, a display, and a user interface.

In the foregoing specification, specific embodiments of the disclosure have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of the disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method for automatically generating video highlights for a video game involving at least one player, the method comprising:
analyzing, by one or more processors, an in-game event stream using an Artificial Intelligence (AI) module, wherein the analyzing comprises extracting game-related information or statistics from the in-game event stream and from one or more data sources using a plurality of Application Programming Interfaces (APIs), wherein the game-related information comprises at least one of in-game behavior of players and skill usages of players;
predicting, by one or more processors, a win probability of the game in real-time based on the game-related information using the AI module;
detecting, by one or more processors, if the win probability of the game fluctuates beyond a predefined threshold using the AI module;
correlating, by one or more processors, one or more significant in-game events from the in-game event stream with win probability fluctuations; and
generating, by one or more processors, video highlights of the game based on the one or more significant in-game events.

2. The method of claim 1, wherein the video game is an online video game comprising at least one of an athletic competition, a match, and a tournament.

3. The method of claim 1, wherein the plurality of APIs comprises official APIs and unofficial APIs, wherein the official APIs provide statistics corresponding to a player's performance and unofficial APIs are third-party APIs which extract information related to the game.

4. The method of claim 1, wherein the one or more data sources comprise replay files, wherein the replay files store game-related information as encrypted event streams.

5. The method of claim 1, wherein the skill usages of players are determined using the AI module based on analyzing the changes in the states of skill icons of players in the game.

6. The method of claim 1, wherein the extracting further comprises tracking, by one or more processors, a player/character such as a champion using a particle filter algorithm to provide an estimation of probable occlusions.

7. The method of claim 1, wherein the AI module comprises a recurrent neural network with an Adam optimizer and a Binary Crossentropy loss function for predicting the win probability of the game using real-time statistics of players comprising at least one of amount of gold, number of kills and deaths in the game, and real-time statistics of each team comprising at least one of tower states and elite monster kills in the game.

8. The method of claim 7, wherein the AI module comprises at least one of recurrent neural network, optical character recognition (OCR), object localizer neural network and specific algorithms for learning a player's gaming behavior.

9. The method of claim 8, wherein the OCR is utilized in combination with the object detection neural network for processing extracted text and location of a character/player on a minimap.

10. The method of claim 1 further comprises automatically curating, by one or more processors, in-game video highlights of professional players for sharing on a website to provide education, personalized coaching, and entertainment for a gaming community.

11. A system for automatically generating video highlights for a video game involving at least one player, the system comprising:
a memory;
a processor communicatively coupled to the memory, wherein the processor is configured to:
analyze an in-game event stream using an Artificial Intelligence (AI) module, wherein the analyzing comprises extracting game-related information or statistics from the in-game event stream and from one or more data sources using a plurality of Application Programming Interfaces (APIs), wherein the game-related information comprises at least one of in-game behavior of players and skill usages of players;
predict a win probability of the game in real-time based on the game-related information using the AI module;
detect if the win probability of the game fluctuates beyond a predefined threshold using the AI module;
correlate one or more significant in-game events from the in-game event stream with win probability fluctuations; and
generate video highlights of the game based on the one or more significant in-game events.

12. The system of claim 11, wherein the plurality of APIs comprises official APIs and unofficial APIs, wherein the official APIs provide statistics corresponding to a player's performance and unofficial APIs are third-party APIs which extract information related to the game.

13. The system of claim 11, wherein the one or more data sources comprise replay files, wherein the replay files store game-related information as encrypted event streams.

14. The system of claim 11, wherein the processor is further configured to track a player/character such as a champion using a particle filter algorithm to provide an estimation of probable occlusions.

15. The system of claim 11, wherein the AI module comprises a recurrent neural network with an Adam optimizer and a Binary Crossentropy loss function for predicting the win probability of the game using real-time statistics of players comprising at least one of amount of gold, number of kills and deaths in the game, and real-time statistics of each team comprising at least one of tower states and elite monster kills in the game.

16. The system of claim 15, wherein the AI module comprises at least one of recurrent neural network, optical character recognition (OCR), object localizer neural network and specific algorithms for learning a player's gaming behavior.

17. The system of claim 16, wherein the OCR is utilized in combination with the object localizer neural network for processing extracted text and location of a character/player on a minimap.

18. The system of claim 11, wherein the processor is further configured to automatically curate in-game video highlights of professional players for sharing on a website to provide education, personalized coaching, and entertainment for a gaming community.
